(19) United States
(12) Patent Application Publication
(10) Pub. No.: US 2013/0229780 A1
(43) Pub. Date: Sep. 5, 2013

(54) PATCH PANEL AND METHOD OF FACILITATING ACCESS TO REAR PORTS OF A COMPONENT

(71) Applicants: Paul Trudeau, Mountain View, CA (US); Angela Ying-Ju Chen, San Francisco, CA (US); William Dailey, Redwood City, CA (US)

(72) Inventors: Paul Trudeau, Mountain View, CA (US); Angela Ying-Ju Chen, San Francisco, CA (US); William Dailey, Redwood City, CA (US)

(73) Assignee: GOOGLE INC., Mountain View, CA (US)

(21) Appl. No.: 13/409,769

(22) Filed: Mar. 1, 2012

(51) Int. Cl. H02B 1/20; B23P 17/04

(52) U.S. Cl. 361/827; 29/428

(57) ABSTRACT

Aspects of the disclosure relate generally to a patch panel for networking components. The patch panel may facilitate access to the rear ports of the networking components. In one example, the patch panel may include a body and a face, and may mount to the networking component. Once mounted, one or more jumpers may be connected to rear ports on the component as well as connection interfaces mounted on the face of the patch panel. In this way, the rear ports may be accessible from the front of the component by the connection interfaces.

### BACKGROUND

In a computing system environment including a plurality of racks for network components, the network components may include ports both on the front and the rear. Such ports may provide connections to other components or may be connected to a power source to provide power to the component. Depending on the arrangement of racks and components, access to the ports in the back may be difficult. Additionally, the ports and corresponding cables in the rear of a network component may prevent the installation of additional devices which interface with the rear of the networking component.

### SUMMARY

One aspect of the disclosure provides a patch panel for a component. According to an aspect of the disclosure, the patch panel may have a substantially planar body and a face arranged substantially perpendicularly to the body. The patch panel may also include a connection interface mounted to the face, the connection interface including at least a first port and a second port. The patch panel may also include at least one jumper having an end adapted to be connected to the connection interface, and wherein the jumper is secured to the body.

In one example, the patch may further include a mounting portion configured to secure the patch panel to the component, wherein the mounting portion comprises at least one aperture adapted to receive a fixation element.

In another example, the patch panel may include at least one fastener securing the at least one jumper to the body. The fastener may include a plurality of fasteners, with the plurality of fasteners arranged to prevent a curvature of the jumper beyond a minimum bend radius. In yet another example, the fastener may be a clamp and screw.

According to another aspect of the disclosure, the body of the patch panel may be formed integrally with the face.

According to one aspect, the first port includes an interior port disposed on an interior surface of the face adjacent to the body, and the second port includes an exterior port disposed on an opposing surface of the face with respect to the interior port. The jumper may be connected to the interior port of the connection interface. The exterior port and interior port may be coupled so as to provide a signal carrying connection between the exterior port and the rear port through the interior port and the at least one jumper. In one example, the at least one jumper is integrally formed with the interior port. The jumper may be selected from a group consisting of a fiber optic cable, a power cable, and a networking cable.

Another aspect of the disclosure provides a rack system including at least one shelf, a component secured within the at least one shelf, and a patch panel secured to the component. The patch panel may include a substantially planar body and a face arranged substantially perpendicularly to the body. The patch panel may further include a connection interface mounted to the face, the connection interface including at least a first port and a second port. The patch panel may also include at least one jumper having a first end and a second end, wherein the first end is adapted to be connected to the connection interface and the second end is adapted to be connect to a rear port of the component, and wherein the jumper is secured to the body.

Another aspect of the disclosure provides a method of facilitating access to a rear port of a component, including providing a patch panel. The patch panel may include a substantially planar body and a face arranged substantially perpendicularly to the body. The patch panel may further include a connection interface mounted to the face, the connection interface including at least a first port and a second port, wherein the first and second port are communicatively coupled. The patch panel may further include at least one jumper having a first end and a second end, wherein the first end is adapted to be connected to the connection interface, and the second end is adapted to be connected to a rear port of the component, and wherein the jumper is secured to the body. The patch panel may then be mounted to the component, and the at least one jumper may be coupled to the rear port of the component. The at least one jumper may then be coupled to the first port of the connection interface thereby providing a connection between the second port and the rear port through the first port and the at least one jumper. The at least one jumper may then be secured to the body. In another example, an external device may be coupled to the second port of the connection interface.

### BRIEF DESCRIPTION OF THE DRAWINGS

FIG. 1 is an example diagram of a rack architecture in accordance with aspects of the disclosure.

FIG. 2 is a view of an exemplary patch panel.

FIG. 3A is a bottom view of an exemplary patch panel according to aspects of the disclosure.

FIG. 3B is a front view of an exemplary patch panel according to aspects of the disclosure.

FIGS. 4A-4B are views of an exemplary patch panel system in accordance with aspects of the disclosure.

FIG. 5 is a flow chart depicting a method of facilitating access to the rear ports of a component according to aspects of the disclosure.

### DETAILED DESCRIPTION

According to aspects of the disclosure, an exemplary patch panel for a component is disclosed. The exemplary patch panel may be secured to a component, such as a networking component, and may allow ports on the rear of the component to be accessed from the front of the component. The patch panel may include a plurality of jumpers, which provide a connection between rear ports of a component and a connection interface mounted to the face of the patch panel. The ports located at the rear of the component may then be accessed at the connection interface on the face of the patch panel.

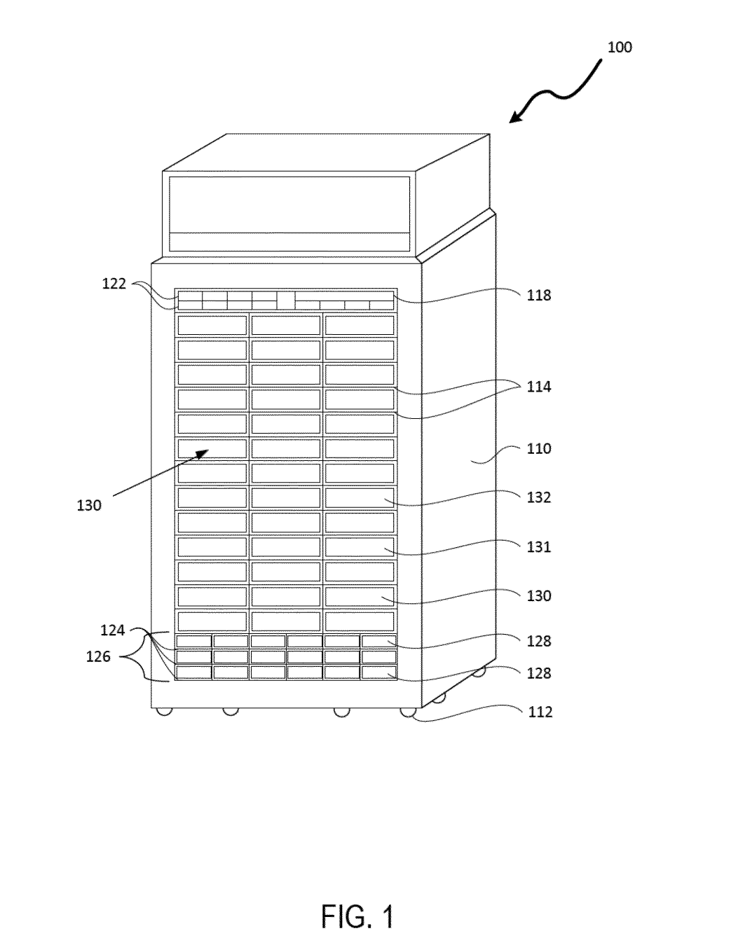

FIG. 1 is an example of a mobile rack server system 100. The server system 100 may include a mobile rack 110 having wheels 112, a plurality of shelves 114 for holding components, a rack monitoring unit (RMU) 118 for monitoring the status of the features of the rack. In addition, the server system 100 may also include a plurality of rectifiers 124, a battery backup 126, battery boxes 128, 129, and a plurality of computing components 130-132. The server system 100 may supply power from a power source to the computing components 130-132. For example, though not shown in the figures, each of the shelves of the rack may be connected, directly or indirectly, to a power supply, such as an AC or DC power source. The power supply may provide power or data to the components 130-132, or battery backup 126 or battery boxes 128, 129. Rectifiers 124 may modify the incoming power from the power supply, and in one example, may convert an incoming AC signal to a DC signal for use by the plurality of computing components 130-132.

As will be described in further detail below, mobile rack 110 may house a plurality of computing components 130-132 which may be used in cooperation with an exemplary patch panel. In one example, the components 130-132 may be networking devices, such as servers, switches, or routers.

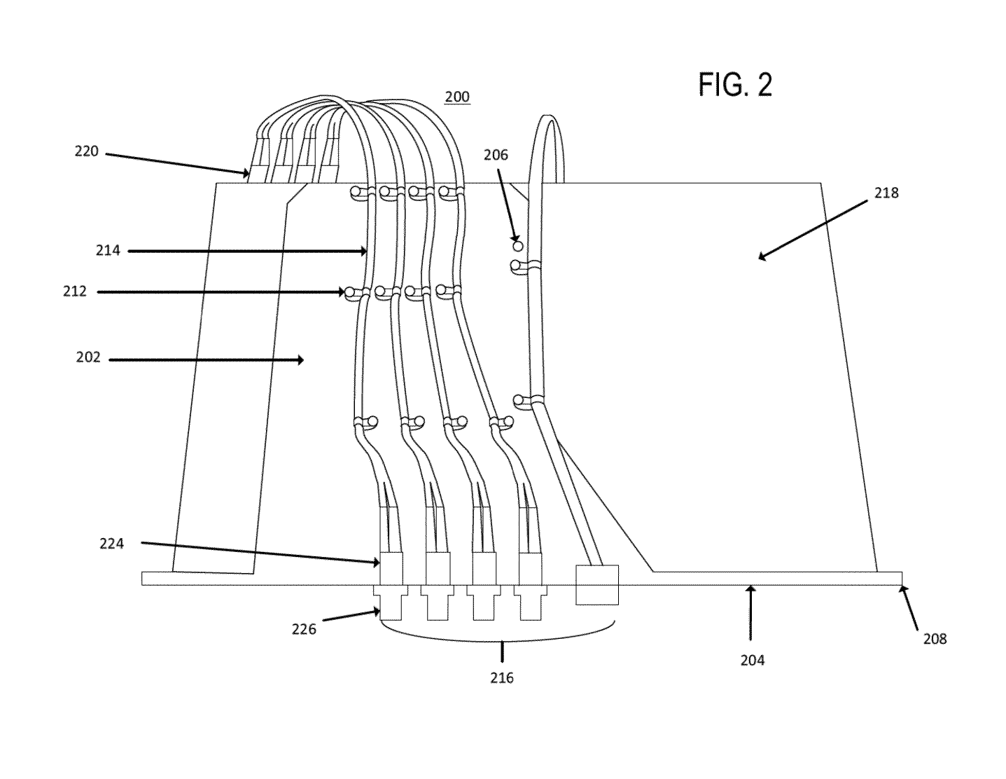

FIG. 2 is a bottom view of an exemplary patch panel 200 according to one aspect of the disclosure. In this example, the patch panel 200 may be mounted to a component 218, which may be any of components 130-132 as shown in FIG. 1. For example, component 218 may be a server, a router, a switch, a host, a storage medium, or any other type of computing device. The component 218, with the mounted patch panel 200, may be housed in a mobile rack, such as the mobile rack 110 of server system 100 of FIG. 1.

Patch panel 200 may include a body 202 and a face 204. Body 202 may be secured to the component 218 and may guide or support a plurality of jumpers from a rear port of the component to the face 204 of the patch panel 200. The face may be attached to the body 202, and may provide a connection interface for the jumpers and provide a connection to the rear ports of the component.

Patch panel 200, including body 202 and face 204, may be made of sheet metal, aluminum, plastic, or any other suitable material. In one example, a material selected for one or both of body 202 and face 204 may be selected so as not to cause an interference with the operation of component 218. A non-magnetic or non-conductive material may be used to prevent such interference. Body 202 and face 204 may be formed of the same material or of different materials. Body 202 and face 204 may also be formed integrally or may be two separate pieces mounted together by welding or some other fixation method.

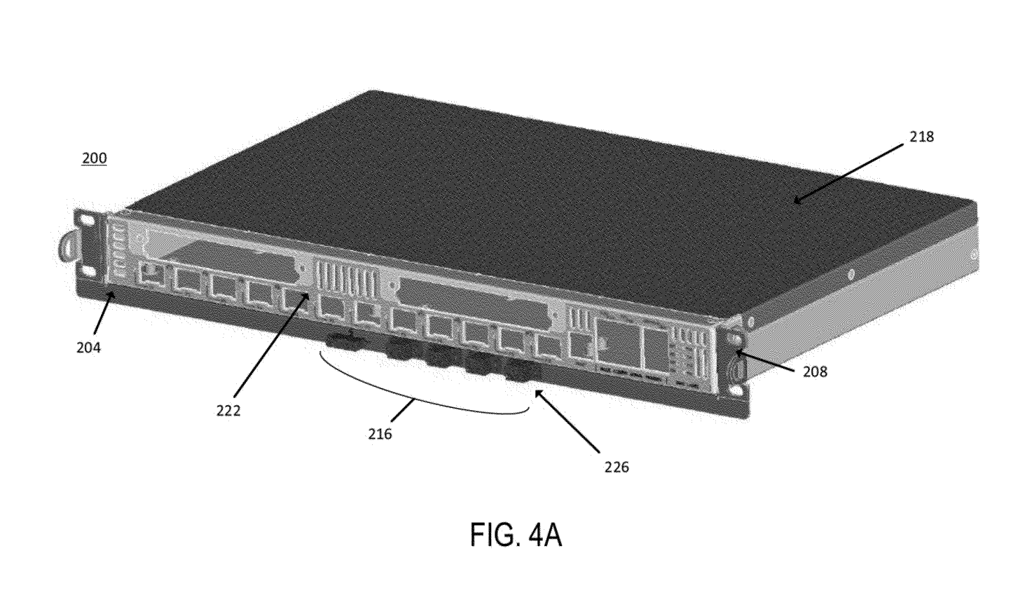

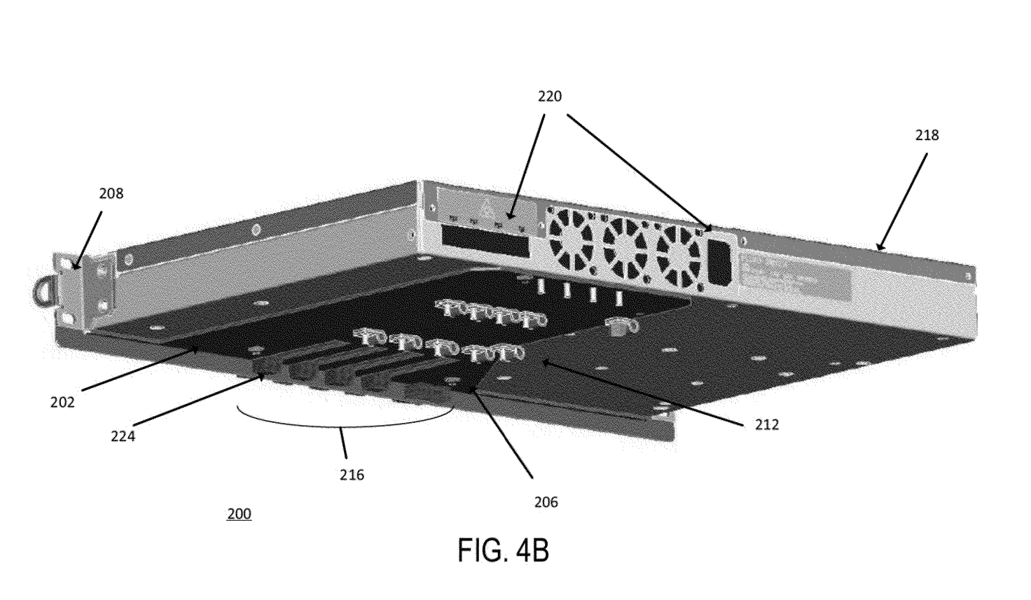

Body 202 may be of any size or dimension appropriate to accommodate a component 218. In one example, body 202 may be substantially planar and may be arranged along a bottom or top surface of component 218. Body 202 may extend from a front portion to the rear portion of the component 218. In one example, component 218 may be shaped as a substantially rectangular box. It is understood that a front portion of component 218 may be a portion accessible by a user when component 218 is secured within a rack as depicted, for example, in FIGS. 1 and 4A. Component 218 may also have a rear portion, opposite the front portion of component 218, which may include rear ports 220 as described below and depicted in FIG. 4B. A length of body 202 may be approximately the length, e.g., +/−1 in. of the component 218 from front to back. Body 202 may have a thickness of approximately 3mm or less to allow a component 218, with a patch panel 200 mounted thereto, to fit securely within a mobile rack. Body 202 may also have a width which corresponds to an arrangement of rear ports of a component 218. For example, if component 218 includes a single port, body 202 may be of a width of approximately two inches to accommodate a single jumper. In another example, body 202 may have up to a width approximately equal to the width of a component 218 where the component has many rear ports which are spaced out.

When a patch panel 200 is mounted to a component, face 204 provides the connection interface which allows connection to the rear ports from the front of the component. Face 204 is arranged along a perimeter of component 218, so as not to overlap or obscure a front panel of component 218, and may extend (e.g., up to approximately an inch) away from the front surface of component 218. Thus, an overall width of face 204 may be wider than 19″ and still allow patch panel 200 to be secured to a mobile rack. Face 204 may be arranged substantially perpendicularly, e.g., +/−5 degrees, to body 202 such that both body 202 and face 204 conform to the shape of the component 218. In one example, face 204 may have a height and width to ensure that the component 218, with a patch panel 200 mounted thereto, fits properly within a 19″ rack.

Patch panel may also include one or more body mounting portions 206, and one or more face mounting portions 208. In this example, the body mounting portions 206 may include one or more apertures which align with corresponding apertures in the component 218. The body 202 may then be secured to the bottom of component 218 with a screw, bolt or any other suitable fixation device. In another implementation, body 202 may be secured to the top of component 218. In such an arrangement, the corresponding apertures on component 218 may be on the top of the component 218. Alternatively, or in combination with body mounting portions 206, face mounting portions 208 may include one or more brackets arranged perpendicular to face portion 204 which engage with a corresponding portion on component 218. In yet another implementation, face mounting portions 208 may include apertures designed to mate with corresponding apertures on a mobile rack for securing the patch panel 200 to the mobile rack.

Patch panel 200 may also include fasteners 212 for securing jumpers 214 (FIG. 2) to body 202. For example, jumpers 214 may include any types of cables which transfer data or power, such as optical fiber cables, power cables, coaxial cables, or any type of networking cables, such as Ethernet cables or twister pair cable. Jumpers 214 may connect to a rear port 220 of the component 218 at one end (e.g., a rear surface of the component 218), and may also connect to a connection interface 216 at another end (e.g., a front surface of the component 218), which will be described in greater detail below. Jumpers 214 may be approximately as long as body 202 and component. In one aspect, jumpers 214 may be optical fiber jumpers, and fasteners 212 may be positioned to maintain an appropriate bend radius to ensure data integrity and prevent mechanical destruction of cables. For example, FIG. 2 depicts a plurality of fasteners 212 for each jumper 214. Starting with the rear point 220 of the component 218, jumper 214 may be secured to body 202 by a first fastener 212 located near the rear portion of the component 218. Since the jumper 214 must complete a 180 degree turn, the first fastener may be located at a position which is offset from the location of the rear point 220, e.g., vertically and/or horizontally offset from a plane which passes through both a front portion and rear portion of component 218. For example, an offset distance may correspond to a minimum bend radius of jumpers 214. In this way, a bend radius of jumper 214 does not surpass the minimum bend radius of the jumper 214 during the 180 degree turn between rear point 220 and the first fastener 212, since a greater offset distance allows an increased bend radius of jumpers 214. The subsequent fasteners 212 may also be oriented to maintain the appropriate bend radius for the jumper 212. A minimum bend radius for jumpers 214 may vary based on a number of factors, such as cable type, material used to form jumpers 214, diameter of jumper 214, as well as other factors. According to an aspect of the disclosure, jumpers 214 may be optical fiber jumpers and may have a diameter of up to approximately 0.5 cm to 1.5 cm, e.g., 0.5 cm to 1.5 cm+/−0.25 cm. A minimum bend radius may be provided as a multiple of the diameter of jumpers 214, depending on the factors discussed above, and in one example may be up to 20 times a diameter of jumpers 214, or 30 cm in the example of a diameter of 1.5 cm. In another example, a minimum bend radius may be 10 times a diameter of jumpers 214, i.e., approximately 10 cm for jumpers 214 with a diameter of 1 cm. It is understood that the diameters and minimum bend radii provided above are not exhaustive, and that any type of cable with any minimum bend radius may be used as one of jumpers 214.

Fasteners 212 may be arranged on the body 202 based on the location and types of rear ports 220. Fasteners 212 may secure jumpers 214 to body 202 by a clamp and screw, a slot and a clip, an integral flanged holding component, or any other appropriate fixation devices. Body 202 may also include a plurality of fastener points 228 thereon for securing fasteners 212 to body 202. In one example, fastener points 228 correspond to fasteners 212. In another example, fastener points 228 may include a plurality of apertures in body 202 for allowing fasteners 212 to be secured directly to component 218. In another example, fastener points 228 may include a plurality of posts that engage with fasteners 212. During installation of jumpers 214, one of jumpers 214 may be inserted into the clamp of fastener 212. Once inserted, the clamp may be tightened by way of a screw. Once tightened, jumper 214 is secured to body 202 and is less prone to movement or disconnection if component 218 is moved. In the example of FIG. 2, the rear ports 220 of component 218 include four optical fiber ports and one power port. Fasteners 212 may be arranged to include three fasteners 212 for each jumper 214 connected to the optical fiber ports, and two fasteners 212 for the jumper 214 connected to the power port. According to one aspect, tightening a screw of fastener 212 both secures the jumper 214 within a channel of the fastener 212, as well as secures the fastener 212 and jumper 214 to body 202. In another example, fasteners 212 may be integral with body 202, and jumpers 214 may be snap-fit within a corresponding channel of fasteners 212. In yet another aspect, fasteners 212 may secure body 202 directly to component 218, in addition to securing jumpers 214. For example, where the fasteners 212 include a clamp and screw, the screw may also affix the panel 200 to the component 218.

Although the jumpers 214 are illustrated in the figures as being fastened to an external surface of the panel 200, it should be understood that the jumpers may alternatively be fastened to the panel 200 between the panel 200 and the component 218. For example, the jumpers 214 may be temporarily, permanently, or semi-permanently affixed (e.g., clipped, clamped, or glued) to an interior surface of the panel 200 prior to affixing the panel 200 to the component 218.

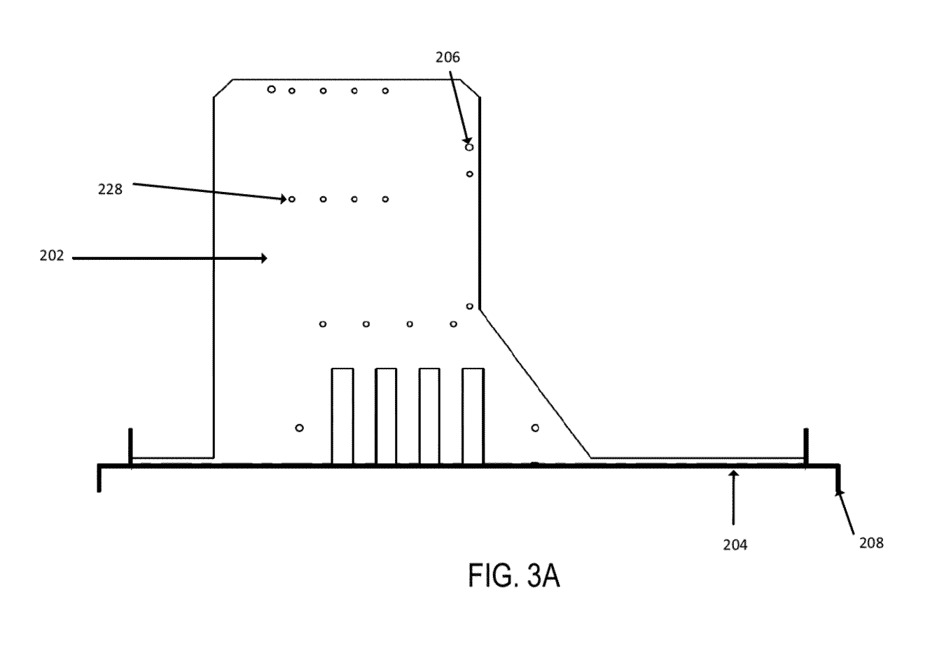

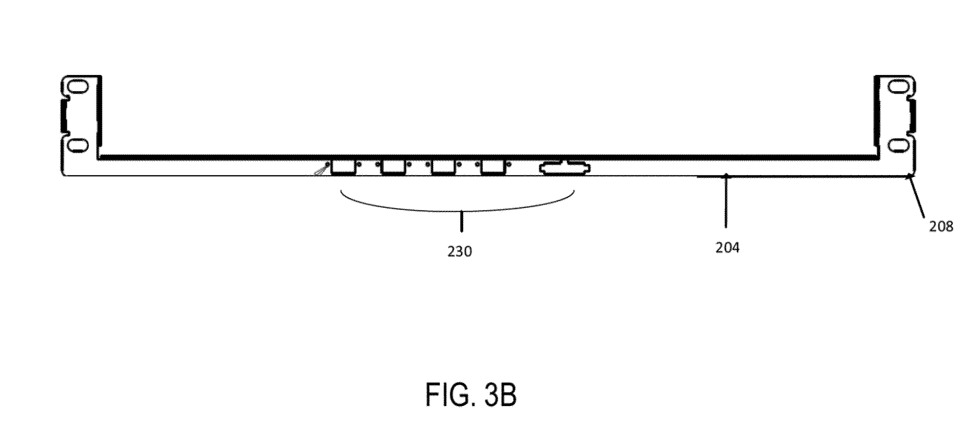

Patch panel 200 may include one or more connection interfaces 216 to which jumpers 214 are connected. Once connected, a user may access the rear ports 220 of component 218 via the connection interface 216. Connection interfaces 216 may be inserted through a plurality of corresponding cutouts 230, as depicted in FIG. 3B. Cutouts 230 may be a plurality of cutout portions in face 204 which allow connection interfaces to pass therethrough. Once connection interfaces 216 are inserted into cutouts 230, they may be secured to the face 204 by any fixation device, such as by a screw and nut. In another example, connection interfaces 216 may include integrally formed snap-features which allow connection interfaces 216 to be snap fit with respect to face 204. Each of the connection interfaces 216 may include an interior port 224 and an exterior port 226. Interior port 224 may be connected to rear ports 220 by way of jumpers 214. Exterior port 226 provides an external connection on face 204, such that a user may access the rear ports 220 on the front of the component 218. Thus, instead of connecting an external cable to rear ports 220, a user may connect it to exterior port 226. In one example, both interior port 224 and exterior port 226 are female ports, and may receive a corresponding connection cable. In another example, interior port 224 may be a male port interface to receive a corresponding jumper 214 with a female interface. In yet another example, jumper 214 may be integral with connection interface 216.

As shown in FIG. 2, jumper 214 may connect at one end to a port on the rear ports 220 of component 218. At the other end, jumper 214 may connect to an interior port 224 of connection interface 216. In this way, interior port 224 may be a portion of connection interface 216 that is accessible at an interior surface of face 204 adjacent body 202, and may be oriented at an interior portion of a plane formed by face 204. Exterior port 226 may be a portion of connection interface 216 that is oriented on an opposing face of the plane formed by face 204. Interior port 224 and exterior port 226 may be communicatively coupled to provide a signal carrying connection therebetween. This communicative coupling may allow jumpers 214 to communicate with exterior port 226. Such communicative coupling may include a connection of any type, such as an electrical connection, an optical connection, or any other type of data or power connection. For example, the interior ports 224 and exterior ports 226 of connection interfaces 216 can be adapted to receive any type of connector that the component 218 is designed to receive, such as any cables which transfer data or power including optical fiber cables, power cables, coaxial cables, or any type of networking cables, such as Ethernet cables or twister pair cable. In one example, the interior ports 224 correspond to the rear ports 220 of component, to allow the use of a jumper 214 with matching ends. When jumpers 214 are secured to both rear ports 220 and interior ports 224, exterior ports 226 may be used to connect to external devices, such as other networking devices, processors, personal computers, or any other device.

FIG. 4A is a front perspective view of an exemplary patch panel according to one aspect of the disclosure. In this example, patch panel 200 is shown mounted to the component 218 by face mounting portion 208. In this example, only the housing of component 218 is depicted, and any internal subcomponents of component 218 are not shown. According to one aspect of the disclosure, face 204 can be arranged such that it does not obscure controls or ports on a front portion of component 218. Face 204 can be arranged below a front portion and to the sides of the component 218 such that it does not overlap with a front panel of a component 218. This allows a user to have full access to the controls and ports on the front of component 218. In another implementation, face 204 can be arranged above a front portion 222 of a component 218. In this case, body 202 (FIG. 2) may be secured to the top of component 218.

As shown in FIG. 4A, connection interfaces 216 and exterior ports 226 are disposed on face 204, allowing for access to the rear ports 220 without having to access the rear of component 218. Connection interfaces 216 may be disposed along a periphery of a front portion of component 218. As shown in FIG. 4A, the face 204 of patch panel 200 may be adjacent to a front portion of component 218, and connection interfaces 216 may be adjacent to the front portion of component 218 near a bottom surface of component 218. In this implementation, connection interfaces 216 are arranged below a front portion of component 218 when secured within a rack architecture. In another example, connection interfaces 216 may be disposed above a front portion of component 218, such that connection interfaces 216 may be adjacent to a front portion of component 218 near a top surface of component 218.

FIG. 4B is a rear perspective view of the exemplary patch panel 200 of FIG. 3A. In this example, jumpers 214 are not secured to body 202. Rather, rear ports 220 can be seen at the rear of component 218. Jumpers 214 may connect to rear ports 220 and may be secured to patch panel 200 by fasteners 212. Jumpers 214 may then be connected to interior ports 224 of connection interface 216.

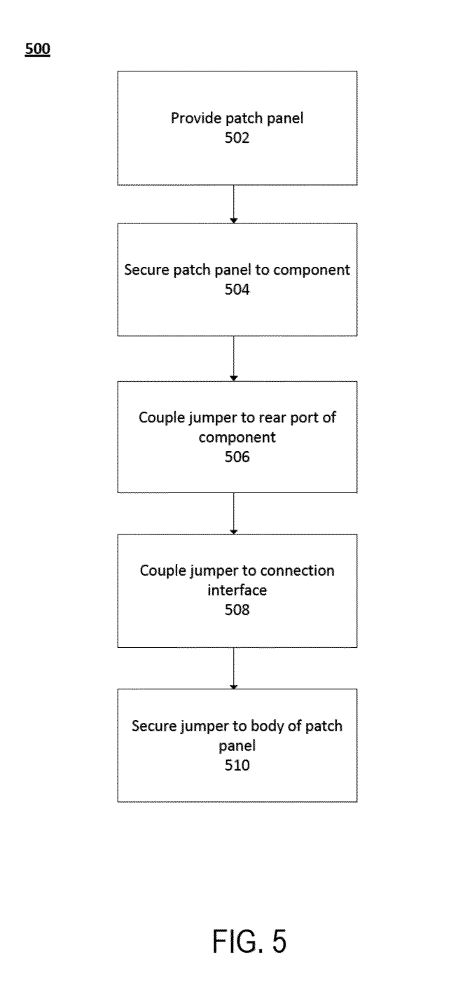

FIG. 5 is a flow chart 500 depicting a method of facilitating access to the rear ports 220 of a component 218 according to aspects of the disclosure.

A patch panel may be provided at block 502. In one example, patch panel may be an exemplary patch panel 200 as described above. While various stages of the method are illustrated and described in a particular order, it should be understood that these stages do not have to be performed in this order. Rather, various stages may be handled in a different order or simultaneously, and stages may also be added or omitted unless otherwise stated.

At block 504, the patch panel 200 may be mounted to a component 218. This may be done by inserting a screw into body mounting portions 206 and threadably engaging the screw with a corresponding aperture on component 218. In another example, fasteners 212 may include a clamp and screw to secure body 202 to component 218. As described above, patch panel 200 may be secured to either a top portion or bottom portion of component 218.

At block 506, one end of a jumper 214 may be coupled to a rear port 220 of a component 218, and at block 508 the other end of the jumper 214 may be secured to a connection interface 216 of the face 204 of patch panel 200. As described above, jumper 214 may include any types of cables which transfer data or power including optical fiber cables, power cables, coaxial cables, or any type of networking cables, such as Ethernet cables or twister pair cable.

At block 510, the jumper 214 may be secured to the body 202 of patch panel 200. Jumper 214 may be secured by way of a fastener 214, such that jumper 214 may be inserted into a clamp and the clamp may be tightened by a screw. Once connected and secured, a user may connect a cable to the connection interface 216 at the front of component 218 instead of the rear port 220 of the component 218.

Securing the patch panel to a networking component, as described above, may allow access to the rear ports of the component without having to physically access the rear portion of a component. Thus, the rear ports may be connected or disconnected to an external device at a connection interface on the face of the patch panel. Based on this, a network administrator need not walk back and forth between a front and a rear of a component for configuration. Additionally, multiple mobile racks may be arranged more efficiently since access to the rear of the individual components is not necessary. Alternatively, when the patch panel is mounted on a component, there is extra space in the rear of the component to install additional devices which may improve operation of the component. In one example, an additional device may include a cooling unit which may be interfaced with the rear of a component to provide increased cooling of the component.

As these and other variations and combinations of the features discussed above can be utilized without departing from the subject matter defined by the claims, the foregoing description of the embodiments should be taken by way of illustration rather than by way of limitation of the subject matter defined by the claims. It will also be understood that the provision of the examples disclosed herein (as well as clauses phrased as “such as,” “including” and the like) should not be interpreted as limiting the claimed subject matter to the specific examples; rather, the examples are intended to illustrate only one of many possible embodiments. Further, the same reference numbers in different drawings may identify the same or similar elements.

1. A patch panel for a component, comprising:
a substantially planar body;
a face arranged substantially perpendicularly to the body;
a connection interface mounted to the face, the connection interface including at least a first port and a second port; and
at least one jumper having an end adapted to be connected to the connection interface, and wherein the jumper is secured to the body.

2. The patch panel of claim 1 further comprising:
a mounting portion configured to secure the patch panel to the component, wherein the mounting portion comprises at least one aperture adapted to receive a fixation element.

3. The patch panel of claim 1, further comprising at least one fastener securing the at least one jumper to the body.

4. The patch panel of claim 3 further comprising a plurality of fasteners, the plurality of fasteners arranged to prevent curvature of the jumper beyond a minimum bend radius.

5. The patch panel of claim 3, wherein the fastener comprises a clamp and screw.

6. The patch panel of claim 1 wherein the body is formed integrally with the face.

7. The patch panel of claim 1, wherein the first port comprises an interior port disposed on an interior surface of the face adjacent to the body, and the second port comprises an exterior port disposed on an opposing surface of the face with respect to the interior port.

8. The patch panel of claim 7 wherein the jumper is connected to the interior port of the connection interface.

9. The patch panel of claim 8, wherein the exterior port and interior port are coupled so as to provide a signal carrying connection between the exterior port and the rear port through the interior port and the at least one jumper.

10. The patch panel of claim 7 wherein the at least one jumper is integrally formed with the interior port.

11. The patch panel of claim 1 wherein the at least one jumper is selected from a group consisting of a fiber optic cable, a power cable, and a networking cable.

12. A rack system comprising:
at least one shelf;
a component secured within the at least one shelf;
a patch panel secured to the component, the patch panel comprising:
a substantially planar body;
a face arranged substantially perpendicularly to the body;
a connection interface mounted to the face, the connection interface including at least a first port and a second port; and
at least one jumper having a first end and a second end, wherein the first end is adapted to be connected to the connection interface and the second end is adapted to be connect to a rear port of the component, and wherein the jumper is secured to the body.

13. The rack system of claim 12 further comprising:
a mounting portion configured to secure the patch panel to the component, wherein the mounting portion comprises at least one aperture adapted to receive a fixation element.

14. The rack system of claim 12, further comprising at least one fastener adapted to secured the at least one jumper to the body.

15. The rack system of claim 14 further comprising a plurality of fasteners, the plurality of fasteners arranged to prevent curvature of the jumper beyond a minimum bend radius.

16. The rack system of claim 14, wherein the fastener comprises a clamp and screw.

17. The rack system of claim 12 wherein the body is formed integrally with the face.

18. The rack system of claim 12, wherein the first port comprises an interior port disposed on an interior surface of the face adjacent to the body, and the at least one second port comprises an exterior port disposed on an opposing surface of the face with respect to the interior port.

19. The rack system of claim 18 wherein the jumper is connected to the interior port of the connection interface.

20. The rack system of claim 19, wherein the exterior port and interior port are coupled so as to provide a signal carrying connection between the exterior port and the rear port through the interior port and the at least one jumper.

21. The rack system of claim 18 wherein the at least one jumper is integrally formed with the interior port.

22. The rack system of claim 12 wherein the at least one jumper is selected from a group consisting of a fiber optic cable, power cable, and networking cable.

23. A method of facilitating access to a rear port of a component, comprising:
providing a patch panel comprising:
a substantially planar body;
a face arranged substantially perpendicularly to the body;
a connection interface mounted to the face, the connection interface including at least a first port and a second port, wherein the first and second port are communicatively coupled; and
at least one jumper having a first end and a second end, wherein the first end is adapted to be connected to the connection interface, and the second end is adapted to be connected to a rear port of the component, and wherein the jumper is secured to the body;
mounting the patch panel to the component;
coupling the at least one jumper to the rear port of the component;
coupling the at least one jumper to the first port of the connection interface thereby providing a connection between the second port and the rear port through the first port and the at least one jumper; and
securing the at least one jumper to the body.

24. The method of claim 23, further comprising:
coupling an external device to the second port of the connection interface.
